(19) United States
(12) Patent Application Publication
(10) Pub. No.: US 2003/0113238 A1
(43) Pub. Date: Jun. 19, 2003

(54) Waste air cleaning device

(76) Inventors: Satpal Bhatnagar, Vaihingen/Enz (DE); Bertram Hummel, Oberboihingen (DE); Bernd Konig, Rutesheim (DE); Erhard Rieder, Herrenberg (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/292,308

(22) Filed: Nov. 12, 2002

(30) Foreign Application Priority Data
Nov. 14, 2001 (DE) 201 18 418.4

(51) Int. Cl. B32B 27/02

(52) U.S. Cl. 422/168

(57) ABSTRACT

A device for thermally or catalytically cleaning waste air containing combustible constituents including a combustion chamber, at least two receptacles containing heat storage mass for heating untreated gas before it is introduced into the combustion chamber and for heating the heat storage mass with cleaned gas from the combustion chamber, an untreated gas channel for feeding the untreated gas into the receptacles and a clean gas channel for discharging the clean gas from the receptacles. Each receptacle contains at least one inlet opening through which untreated gas is introduced into the receptacle from an untreated gas channel and at least one outlet opening through which cleaned gas is discharged from the receptacle into the clean gas channel. The inlet opening leads into a precombustion chamber between the inlet opening and the heat storage mass of the receptacle.

The present invention pertains to a device for thermally and/or catalytically cleaning waste air that contains combustible constituents, wherein said device comprises a combustion chamber, at least two receptacles containing heat storage mass, through which gases are able to flow, for heating the waste air (untreated gas) to be cleaned before it is introduced into the combustion chamber and for heating the heat storage mass with the cleaned waste air (clean gas) arriving from the combustion chamber, an untreated gas channel for feeding the untreated gas into the receptacles and a clean gas channel for discharging the clean gas from the receptacles, wherein each receptacle contains at least one inlet opening through which untreated gas is introduced into the receptacle from an untreated gas channel and at least one outlet opening through which clean gas is discharged from the receptacle into the clean gas channel, and wherein the inlet opening leads into a precombustion chamber arranged between the inlet opening and the heat storage mass of the receptacle.

A waste air cleaning device of this type is known from DE 195 19 868 A1 for example.

In this and other known waste air cleaning devices of the initially mentioned type, the inlet opening and the outlet opening of each heat storage mass receptacle are oriented horizontally, and the waste air flows through the heat storage mass of the receptacle in the vertical direction such that the normal lines of the surfaces of the inlet opening and the outlet opening are oriented parallel to the mean flow direction through the heat storage mass of the receptacle.

Since the inlet opening and the outlet opening of the receptacle are arranged adjacent to one another in a plane normal to the mean flow direction through the heat storage mass of the receptacle, a very uneven flow distribution results, particularly in the lower region of the heat storage mass. Thus, the heat retention capacity of the heat exchanger mass is not optimally utilized.

The present invention is based on the objective of developing a device of the initially described type in which the heat retention capacity of the heat exchanger mass is better utilized.

According to the invention, this objective is attained with a device with the characteristics of the preamble of claim 1 in that the surface normal of at least one inlet opening of at least one heat storage mass receptacle is oriented transverse to the mean flow direction through the heat storage mass of the receptacle, and in that the precombustion chamber has a section with a cross section that widens toward the heat storage mass.

If the inlet opening is not planar, the term surface normal of the inlet opening refers to the mean surface normal of the inlet opening.

Since the surface normal of the inlet opening in the device according to the invention is not oriented parallel but transverse to the mean flow direction through the heat storage mass of the receptacle, the asymmetry of the flow of the supplied waste air against the heat storage mass is reduced such that the waste air flowing through the heat exchanger mass becomes more uniform and the heat exchanger mass is better utilized. This means that a higher degree of efficiency is achieved at a predetermined pressure loss or that a lower pressure loss is achieved at a predetermined degree of efficiency.

The flow through the heat storage mass becomes even more uniform if the precombustion chamber widens toward the heat storage mass.

The widening of the precombustion chamber cross section may be realized continuously or in discrete increments (step-by-step).

Specifically, the given section of the precombustion chamber can be widened toward the heat storage mass in the form of a roof or a funnel.

It is particularly advantageous if the surface normal of at least one inlet opening of at least one receptacle is oriented essentially perpendicular to the mean flow direction through the heat storage mass of the receptacle.

In principle, the surface normal of the inlet opening may assume any arbitrary orientation relative to the vertical as long as it is oriented transverse to the mean flow direction through the heat storage mass of the given receptacle.

According to a preferred embodiment of the device according to the invention, the surface normal of at least one inlet opening of at least one receptacle is oriented transverse, in particular, essentially perpendicular, to the vertical.

In this case, the mean flow direction through the heat storage mass preferably is oriented essentially vertical.

In one preferred embodiment of the device according to the invention, the surface normal of at least one outlet opening of at least one receptacle is oriented transverse to the mean flow direction through the heat storage mass of the receptacle.

It is preferred that the surface normal of least one outlet opening of at least one receptacle be oriented essentially perpendicular to the mean flow direction through the heat storage mass of the receptacle.

In principle, the surface normal of the outlet opening may assume any arbitrary orientation relative to the vertical as long as it is transverse to the mean flow direction through the heat storage mass of the given receptacle.

It is particularly advantageous if the surface normal of at least one outlet opening of at least one receptacle is oriented transverse, in particular, essentially perpendicular to the vertical.

In this case, the mean flow direction through the heat storage mass is preferably oriented essentially vertical.

It is particularly advantageous if at least one inlet opening and at least one outlet opening of at least one receptacle be realized and arranged symmetrically to one another relative to a central longitudinal plane of the receptacle.

In particular, it is possible that at least one inlet opening and at least one outlet opening of at least one receptacle have mutually parallel surface normals through their respective centroids.

In order easily to control the introduction of untreated gas into the receptacle and/or the discharge of clean gas from the receptacle, the invention advantageously proposes that at least one inlet opening and/or at least one outlet opening of at least one receptacle be closed by means of a valve.

In one preferred embodiment of the device according to the invention, the valve is realized in the form of a disk valve.

In particular, it is possible for the valve to contain an essentially disk-shaped valve body that is oriented essentially parallel to the inlet opening and essentially parallel to the outlet opening in its closed position.

It is also possible for the valve to contain an essentially disk-shaped valve body that is oriented essentially parallel to the inlet opening and essentially parallel to the outlet opening in its open position.

In order to ensure a simple actuation of the valve, it is advantageous that the device comprise an actuating device for moving the valve body from the open position to the closed position and from the closed position to the open position.

Specifically, this actuating device may be realized in pneumatic and/or hydraulic from.

In order to render the flow of the waste air through the heat storage mass even more uniform, it is advantageous if at least one outlet opening of at least one receptacle also leads into a precombustion chamber arranged between the outlet opening and the heat storage mass of the receptacle.

It is preferred that the inlet opening and the outlet opening of the receptacle lead into the same precombustion chamber.

It is furthermore advantageous if the precombustion chamber has not only a widened section, but also a section with an essentially constant cross section.

The term cross section of a section of the precombustion chamber refers to the cross section measured perpendicular to the mean flow direction through the heat storage mass of the given receptacle.

It is particularly advantageous if at least one inlet opening and/or at least one outlet opening of the receptacle lead into the section of the precombustion chamber which has an essentially constant cross section.

The precombustion chamber can be manufactured in a particularly simple fashion if it has an essentially rectangular cross section.

The precombustion chamber may be directly connected to the untreated gas channel via the inlet opening or to a branch line that branches off the untreated gas channel.

The precombustion chamber may also be directly connected to the clean gas channel via the outlet opening or to a branch line that leads into the clean gas channel.

Other characteristics and advantages of the invention form the object of the following description and the diagrammatic illustration of an embodiment example.

The drawings show:

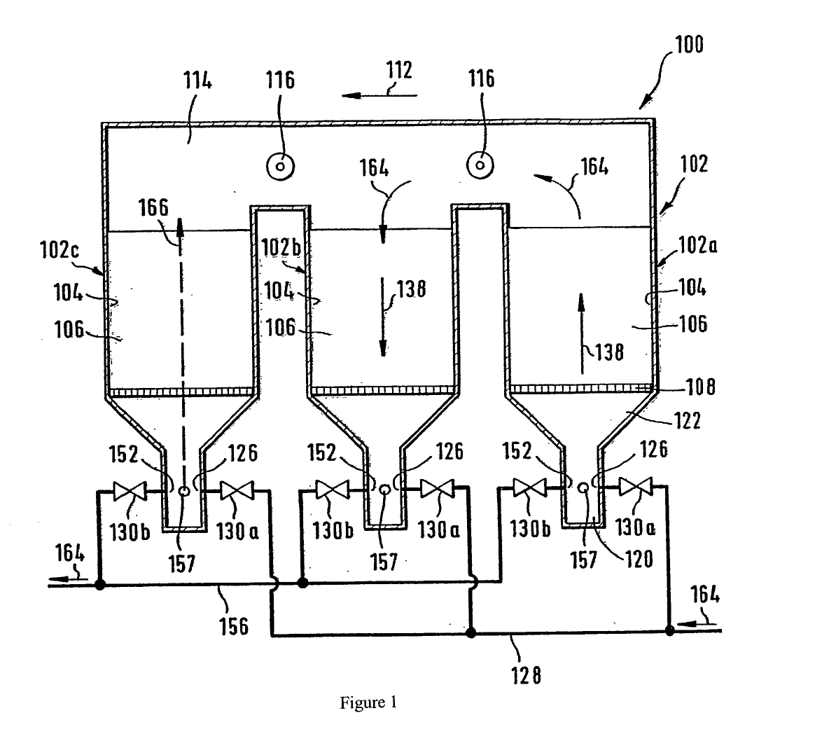

FIG. 1, a schematic longitudinal section through the heat storage mass receptacles of the waste air cleaning device;

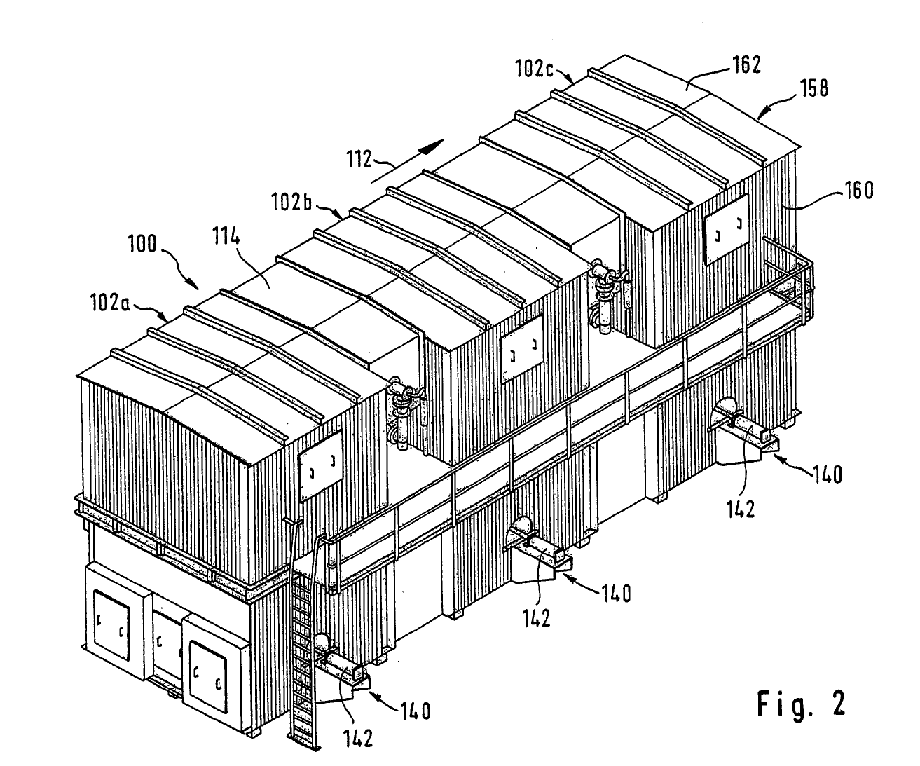

FIG. 2, a perspective representation of the waste air cleaning device shown in FIG. 1;

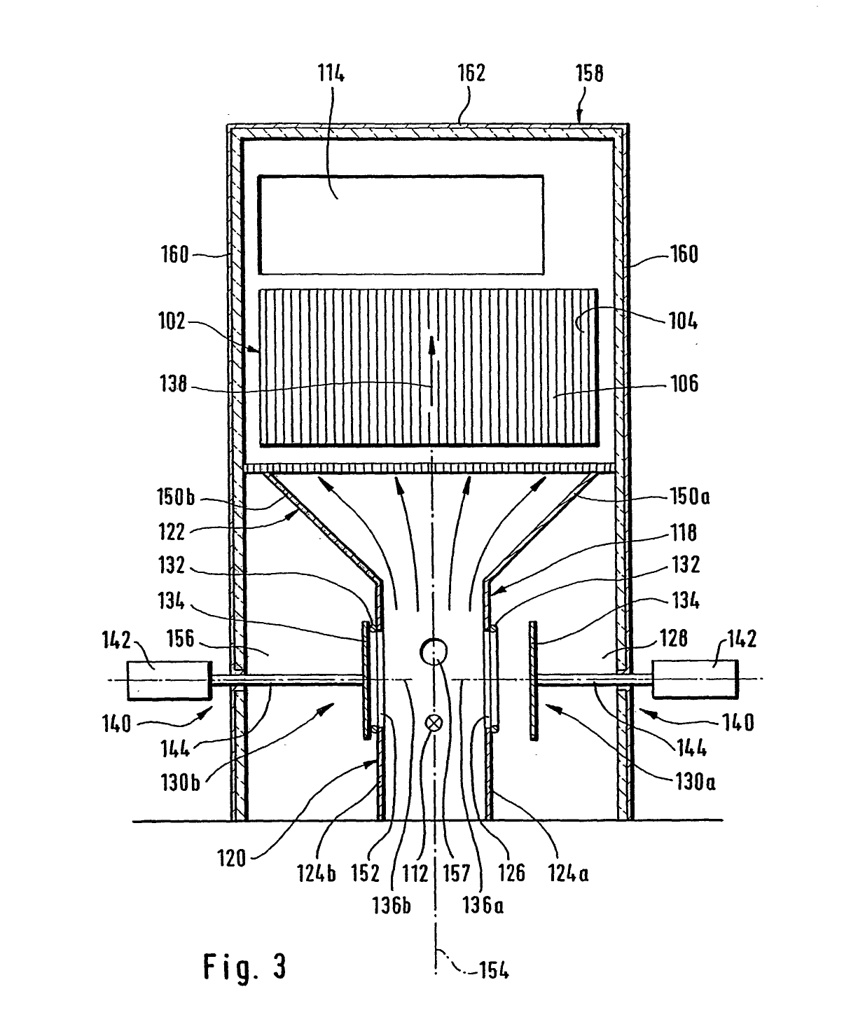

FIG. 3, a schematic vertical section through one of the heat storage mass receptacles of the waste air cleaning device shown in FIGS. 1 and 2;

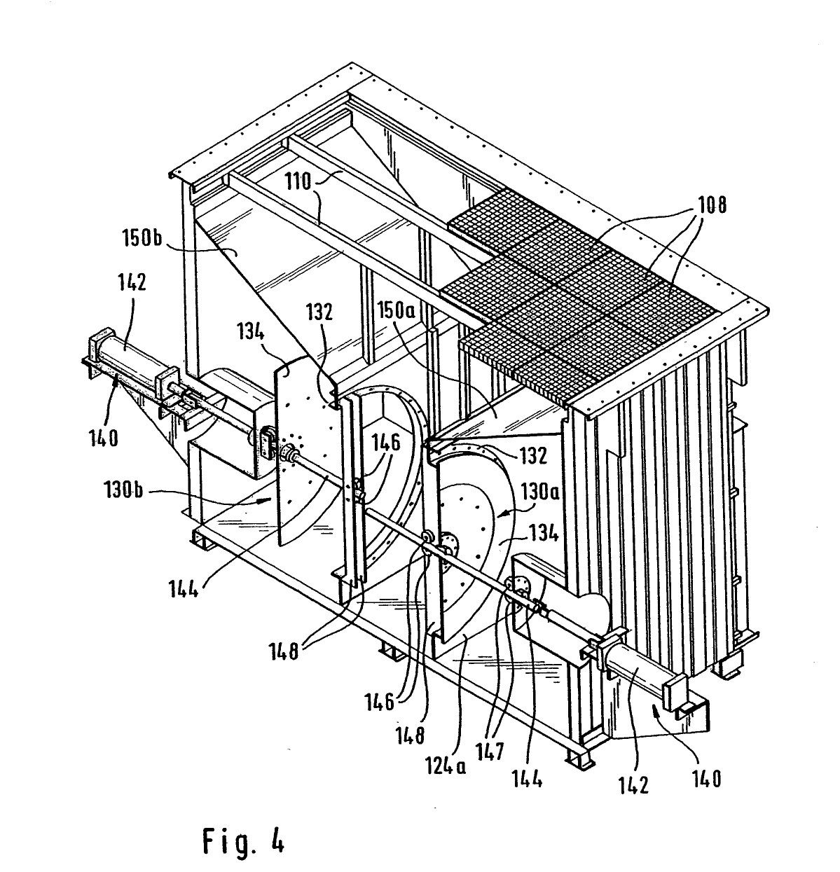

FIG. 4, a perspective representation of a combustion chamber of the heat storage mass receptacle shown in FIG. 3, with an inlet opening and an outlet opening which can be respectively closed;

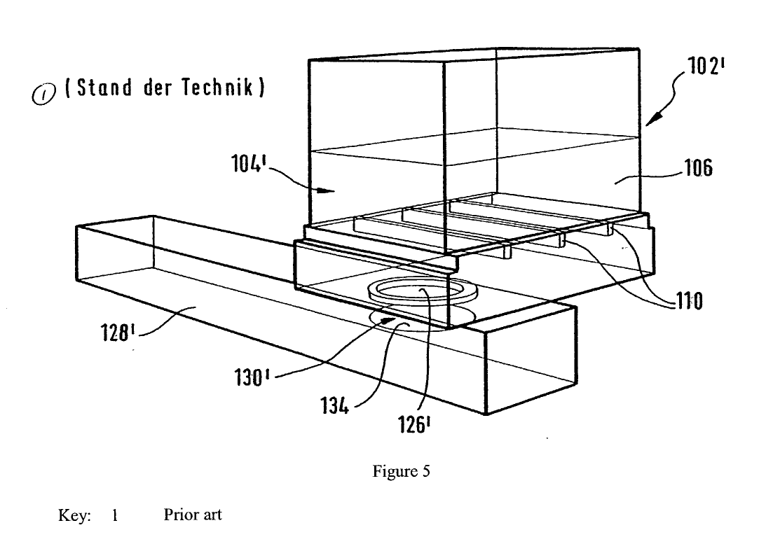

FIG. 5, a schematic perspective representation of an untreated gas channel and a heat storage mass receptacle of a waste air cleaning device according to the prior art;

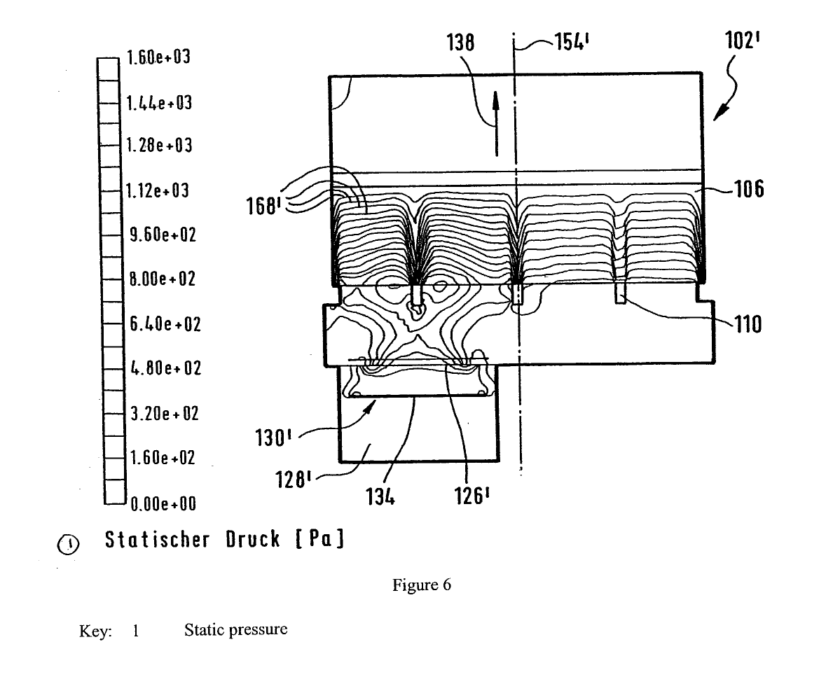

FIG. 6, an illustration of the static pressure distribution in the untreated gas channel and the heat storage mass receptacle shown in FIG. 5;

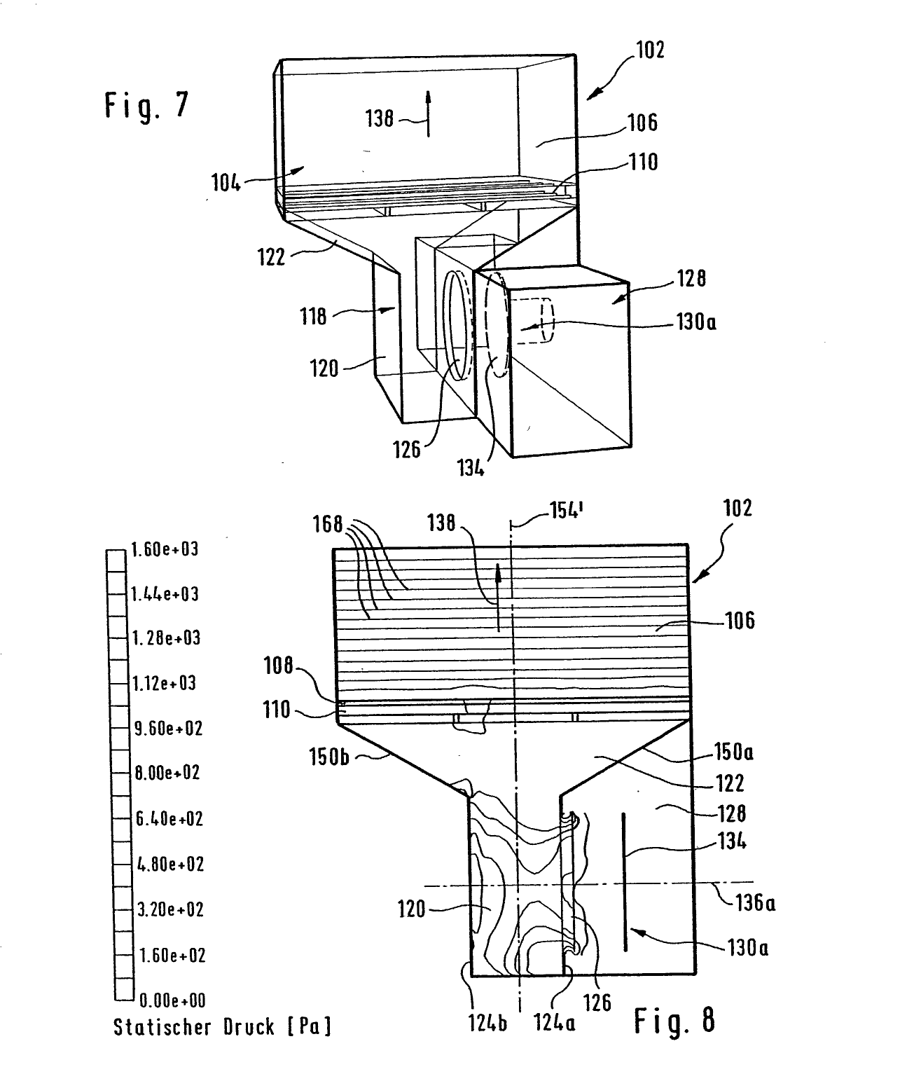

FIG. 7, a schematic perspective representation of an untreated gas channel and a heat storage mass receptacle according to the invention; and

FIG. 8, an illustration of the static pressure distribution in the untreated gas channel and the heat storage mass receptacle shown in FIG. 7.

Identical or equivalently functioning elements are identified by the same reference numerals in all figures.

A waste air cleaning device that is illustrated in FIGS. 1-4, 7 and 8 and identified by the reference numeral 100 comprises three heat storage mass receptacles 102 that are arranged one behind another in the longitudinal direction 112, wherein the first receptacle is identified by the reference numeral 102a, the second, central receptacle is identified by the reference numeral 102b and the third receptacle is identified by the reference numeral 102c.

Each heat storage mass receptacle 102 comprises an essentially cuboidal heat storage mass chamber 104 that is filled with a heat storage mass 106.

This heat storage mass 106 may comprise, for example, saddle elements of a ceramic material that are arranged in the heat storage mass chamber 104 in an unordered manner.

Alternatively or additionally, the heat storage mass 106 may comprise honeycomb elements that are penetrated by gas passage channels and realized in the form of a prism, in particular, a cuboid. The outer surfaces of these honeycomb elements adjoin one another in such a way that one or more layers of honeycomb elements are formed in the heat storage mass chamber 104. The gas must pass through these layers of honeycomb elements during its passage through the heat storage mass chamber 104.

The heat storage mass 106 rests on grating 108, which, in turn, is supported by crosspieces 110 (see FIG. 4).

On the upper end, each of the heat storage mass chambers 104 leads into a combustion chamber 114 that extends over all three heat storage mass receptacles 102 in the longitudinal direction 112 of the waste air cleaning device 100. The combustion chamber contains one or more burners 116, wherein a fuel, for example, a combustible gas, is fed to said burners in order to combust the harmful substances contained in the waste air to be cleaned (see FIG. 3).

If the waste air to be cleaned contains harmful substances of suitable type and concentration, the waste air cleaning device 100 may be operated autothermically at steady state, i.e., without supplying additional fuel. In this case, the burners 116 are only required during the start-up phase of the waste air cleaning device 100 for initiating the combustion in the combustion chamber 114. Once steady-state operation is reached, the burners 116 can be switched off.

Instead of carrying out thermal combustion, it is also possible to subject the harmful substances contained in the waste air to be cleaned by catalytic oxidation. The catalyst required for this purpose may be arranged on the heat storage mass 106, for example. The heat storage mass 106 may, in particular, be provided with a catalytically active coating or be entirely manufactured from a catalytically active material.

FIG. 3 clearly shows that each heat storage mass receptacle 102 contains a precombustion chamber 118 that is arranged underneath the heat storage mass chamber 104. This precombustion chamber comprises an essentially cuboidal lower section 120 with a smaller horizontal cross section than the heat storage mass chamber 104 and an upper section 122. This upper section widens toward the heat storage mass chamber 104 in the form of a funnel, with the lower section 120 leading into the upper section.

On its lower end, the upper section 122 has a horizontal cross section that corresponds to that of the lower section 120, with the horizontal cross section on its upper end corresponding to the horizontal cross section of the heat storage mass chamber 104 situated on top of it.

The lower section 120 of each precombustion chamber 118 has a first vertical side wall 124a that extends parallel to the longitudinal direction 112 of the waste air cleaning device 100 and in which an essentially circular inlet opening 126 is arranged. The lower section 120 of the precombustion chamber 118 is connected to an untreated gas channel 128 extending parallel to the longitudinal direction 112 of the waste air cleaning device 100 via the above-mentioned inlet opening.

The waste air to be cleaned which is referred to as the untreated gas below is fed to the waste air cleaning device through the untreated gas channel 128.

FIGS. 3 and 4 clearly show that the inlet opening 126 can be closed by means of a first disk valve 130a, wherein this disk valve comprises an annular valve seat 132 that surrounds the inlet opening 126 and a valve body 134 in the form of a circular disk which covers the inlet opening 126.

The inlet opening 126 is oriented vertically such that its surface normal 136a is oriented horizontally and consequently perpendicular to the mean flow direction 138 in the heat storage mass 106.

An actuating device 140 is provided for moving the valve body 134 of the disk valve 130a between a closed position, in which the valve body 134 lies against the valve body 134 [sic; valve seat 132] in essentially gas-tight fashion on the side of the untreated gas channel, and an open position, in which the valve body 134 is separated from the valve seat 132 and is located within the untreated gas channel 128.

The actuating device 140 may consist, for example, of a pneumatic actuation device that comprises a pneumatic cylinder 142, in which a piston (not shown) can be displaced between two end positions by means of compressed air. The piston is rigidly connected to the valve body 134 by means of a connecting rod 144 such that the valve body 134 follows the movement of the piston.

FIG. 4 shows that the free end of the connecting rod 144, which faces away from the piston, is guided between two guide rollers 146 that are respectively supported on two vertical supports 148 such that they can be turned about a horizontal axis of rotation that is oriented perpendicular to the surface normal 136a of the inlet opening 126. The vertical supports extend in the vertical direction transverse to the inlet opening 126, from its upper edge to its lower edge.

Between the piston and the guide rollers 146, the connecting rod is additionally guided between another pair of guide rollers 147.

FIG. 3 clearly shows that the side wall 124a of the lower section 120 of the precombustion chamber 118 forms a lateral limitation of the untreated gas channel 128. In addition, a side wall 150a that is inclined relative to the horizontal by an angle of approximately 45° forms an upper limitation of the untreated gas channel 128.

A side wall 124b that is located opposite of the side wall 124a of the lower section 120 of the precombustion chamber 118 and oriented essentially parallel to the side wall 124a contains a circular inlet opening 152 that is essentially realized in the form of a mirror image of the inlet opening 126 relative to the vertical plane 154 extending through the longitudinal center of the precombustion chamber 118. The surface normal 136b of the outlet opening 152 that passes through the centroid of the outlet opening 152 is oriented parallel to the surface normal 136a that passes through the centroid of the inlet opening 126.

The surface normal 136b of the outlet opening 152 consequently is also oriented horizontally and perpendicularly to the mean flow direction 138 of the gas through the heat storage mass 106.

The precombustion chamber 118 is connected to a clean gas channel 156 that extends parallel to the longitudinal direction 112 of the waste air cleaning device via the outlet opening 152, with the clean gas channel serving for discharge of the cleaned waste air from the waste air cleaning device 100.

The waste air that was cleaned by combusting the harmful substances in the combustion chamber 114 is referred to as the clean gas below.

FIG. 3 shows that the side wall 124b of the lower section 120 of the precombustion chamber 118 forms a lateral limitation of the clean gas channel 156. In addition, a side wall 150b of the upper section 122 of the precombustion chamber 118 which is inclined relative to the horizontal line by an angle of approximately 45° forms an upper limitation of the clean gas channel 156.

Like the inlet opening 126, the outlet opening can also be closed by means of a disk valve 130b.

The disk valve 130b is realized in the form of a mirror image of the disk valve 130a, relative to the central longitudinal plane 154 of the precombustion chamber 118, and comprises, in particular, an actuating device 140, a connecting rod 144, a valve seat 132 that annularly surrounds the outlet opening 152 and a valve body 134 that has the form of a circular disk and can be moved between a closed position, in which the valve body 134 lies tightly against the valve seat 132, and an open position, in which the valve body 134 is separated from the valve seat 132 and is located within the clean gas channel 156.

Viewed in the vertical direction, the surface normal 136b that passes through the centroid of the outlet opening 152 is offset a few centimeters relative to the surface normal 136a that passes through the centroid of the inlet opening 126, perpendicularly to the longitudinal direction of the connecting rods 144, in order to prevent the connecting rods 144 of the disk valves 130a and 103b [sic; 130b] from interfering with one another.

In addition, a flushing gas line (not shown) leads into the lower section 120 of the precombustion chamber 118, i.e., at a flushing gas inlet opening 157 can be closed by means of a valve (not shown). A flushing gas, for example, fresh air, can be fed to the precombustion chamber 118 through this flushing gas line in order to purge residual untreated gas from the heat storage mass receptacle 102 into the combustion chamber 114.

The heat storage mass receptacle 102, the combustion chamber 114, the untreated gas channel 128 and the clean gas channel 156 are arranged in a housing 158 of the waste air cleaning device 100, the lateral outside walls 160 and the upper wall 162 of which are provided with heat insulation in order to prevent the loss of heat from the waste air cleaning device 100 to the surroundings. The efficiency of the waste air cleaning device 100 is thereby not impaired.

The previously described waste air cleaning device 100 functions as described below:

Untreated gas from an untreated gas source, for example, a lacquering facility, is fed to the waste air cleaning device 100 through the untreated gas channel 128.

In a first operating state, the disk valve 130a of the first heat storage mass receptacle 102a, for example, is open while the disk valve 130b of the same heat storage mass receptacle 102a is closed. Thus, the untreated gas is introduced into the precombustion chamber 118 of the first heat storage mass receptacle 102a through its inlet opening 126 and then into the heat storage mass chamber 104 from the aforementioned precombustion chamber.

The flow direction of the waste air through the waste air cleaning device 100 is indicated by the arrows 164 in the figures.

A very uniform flow in the heat storage mass 106 of the heat storage mass receptacle 102a is achieved due to the vertical orientation of the inlet opening 126 and the funnel-shaped widening of the flow cross section of the upper section 122 of the precombustion chamber 118, wherein the isobars 168 of this uniform flow are oriented essentially perpendicular to the mean flow direction 138 through the heat storage mass 106. FIG. 8 shows the static pressure distribution in the arrangement according to FIG. 7 which was obtained from a computer simulation.

This uniform flow against the heat exchanger material results in optimal utilization of the heat exchanger mass 106 and consequently a higher degree of efficiency at a predetermined pressure loss or a lower pressure loss at a predetermined degree of efficiency.

FIGS. 5 and 6 show a waste air cleaning device according to the state of the art, in which the lower side of a heat storage mass receptacle 102′ is connected to an untreated gas channel 128′ that extends underneath the heat storage mass receptacle 102″ via a horizontally oriented inlet opening 126′ that can be closed with a horizontally arranged disk valve 130′. Here, the highly asymmetric arrangement of the inlet opening 126′ relative to the central longitudinal plane 154′ of the precombustion chamber 118′ of the heat storage mass receptacle 102′ results in a very uneven flow distribution in the heat storage mass chamber 104′—at least in the lower region of the heat storage mass 106—and consequently a less than optimal utilization of the heat exchanger mass 106. FIG. 6 shows the static pressure distribution with the isobars 168′ in the arrangement according to FIG. 5 which was obtained from a computer simulation.

The heat storage mass 106 of the first heat storage mass receptacle 102a has a relatively high temperature in the first operating state such that it heats the untreated gas which upwardly flows through the heat storage mass 106. The heated untreated gas is thereby introduced into the combustion chamber 114 at the upper end of the first heat storage mass receptacle 102a and then cleaned in the combustion chamber 114, whereby the harmful substances contained therein are thermally oxidized.

The clean gas thereby obtained that is now free of harmful substances flows (as seen in the viewing direction of FIG. 1) through the combustion chamber 114 from right to left and is then introduced into the heat storage mass chamber 104 of the second heat storage mass receptacle 102b via its inlet opening. While downwardly flowing through the heat storage mass 106 contained in the heat storage mass receptacle 102b, the hot clean gas liberates heat to heat the aforementioned heat storage mass before it is discharged from the heat storage mass receptacle 102b through its precombustion chamber 118 and the open disk valve 130b at the outlet opening 152 of the heat storage mass receptacle 102b.

The inlet opening 126 of the second heat storage mass receptacle 102b is closed by the disk valve 130a in this operating state.

The clean gas discharged from the heat storage mass receptacle 102b is carried away from the waste air cleaning device through the clean gas channel 156 and fed to a waste air chimney, for example.

In this first operating state, a flushing gas from the flushing gas line (not shown) flows upwardly through the third heat storage mass receptacle 102c in order to carry the residual untreated gas remaining in the precombustion chamber 118 and in the heat storage mass chamber 104 of this third heat storage mass receptacle 102c into the combustion chamber 114 where it is cleaned by means of thermal oxidation. The direction of flow of the flushing gas is indicated by the broken arrow 166 in FIG. 1.

The two disk valves 130a and 130b of the third heat storage mass receptacle 102c are closed in this purging of the heat storage mass receptacle 102c.

After a predetermined cycle time, the waste air cleaning device 100 is switched to the second operating state, in which the inlet opening 126 of the second heat storage mass receptacle 102b is open and its outlet opening 152 is closed such that the untreated gas now flows into the combustion chamber 114 through the second heat storage mass receptacle 102b, with the untreated gas being heated during its passage through the heat storage mass 106 of the heat storage mass receptacle 102b which was heated during the previous operating state.

The outlet opening 152 of the heat storage mass receptacle 102c that was purged during the previous operating state is now open such that the clean gas can be discharged into the clean gas channel 156 from the heat storage mass 106 of the third heat storage mass receptacle 102c while heating the heat storage mass 106 of the third heat storage mass receptacle 102c.

The first heat storage mass receptacle 102a is now in purging mode, in which the inlet opening 126 and the outlet opening 152 of this heat storage mass receptacle are closed.

The waste air cleaning device 100 then switches from the second operating state to a third operating state, in which the untreated gas is introduced into the combustion chamber 114 through the third heat storage mass receptacle 102c, the clean gas is discharged into the clean gas channel 156 through the first heat storage mass receptacle 102a and the second heat storage mass receptacle 102b is purged.

After this third operating state, one cycle of the waste air cleaning device 100 is completed. The next operating cycle begins by switching over the waste air cleaning device 100 to the above-described first operating state.

1. Device for thermally and/or catalytically cleaning waste air that contains combustible constituents, wherein said device comprises a combustion chamber (114), at least two receptacles (102) containing heat storage mass (106), through which gases are able to flow, for heating the waste air (untreated gas) to be cleaned before it is introduced into the combustion chamber (114) and for heating the heat storage mass (106) with the cleaned waste gas (clean gas) arriving from the combustion chamber (114), an untreated gas channel (128) for feeding the untreated gas to the receptacles (102) and a clean gas channel (156) for discharging the clean gas from the receptacles (102), wherein each receptacle (102) contains at least one inlet opening (126) through which untreated gas is introduced into the receptacle (102) from an untreated gas channel (128) and at least one outlet opening (152) through which clean gas is discharged from the receptacle (102) into the clean gas channel (156), and wherein the inlet opening (126) leads into a precombustion chamber (118) arranged between the inlet opening (126) and the heat storage mass (106) of the receptacle (102), characterized by the fact that the surface normal (136a) of at least one inlet opening (126) of at least one heat storage mass receptacle (102) is oriented transverse to the mean flow direction (138) through the heat storage mass (106) of the receptacle (102), and by the fact that the precombustion chamber (118) has a section (122) with a cross section that widens toward the heat storage mass (106).

2. Device according to claim 1, characterized by the fact that the surface normal (136a) of at least one inlet opening (126) of at least one receptacle (102) is oriented essentially perpendicular to the mean flow direction (138) through the heat storage mass (106) of the receptacle (102).

3. Device according to claim 1 or 2, characterized by the fact that the surface normal (136a) of at least one inlet opening (126) of at least one receptacle (102) is oriented transverse, in particular, essentially perpendicular, to the vertical.

4. Device according to one of claims 1-3, characterized by the fact that the surface normal (136b) of at least one outlet opening (152) of at least one receptacle (102) is oriented transverse to the mean flow direction (138) through the heat storage mass (106) of the receptacle (102).

5. Device according to claim 4, characterized by the fact that the surface normal (136b) of at least one outlet opening (152) of at least one receptacle (102) is oriented essentially perpendicular to the mean flow direction (138) through the heat storage mass (106) of the receptacle (102).

6. Device according to one of claims 1-5, characterized by the fact that the surface normal (136b) of at least one outlet opening (152) of at least one receptacle (102) is oriented transverse, in particular, essentially perpendicular, to the vertical.

7. Device according to one of claims 1-6, characterized by the fact that at least one inlet opening (126) and at least one outlet opening (152) of at least one receptacle (102) are essentially realized and arranged symmetrically to one another relative to a central longitudinal plane (154) of the receptacle (102).

8. Device according to one of claims 1-7, characterized by the fact that at least one inlet opening (126) and at least one outlet opening (152) of at least one receptacle (102) have mutually parallel surface normals (136a, 136b) through their respective centroids.

9. Device according to one of claims 1-8, characterized by the fact that at least one inlet opening (126) and/or at least one outlet opening (152) of at least one receptacle (102) can be closed by means of a valve.

10. Device according to claim 9, characterized by the fact that the valve is realized in the form of the disk valve (130a, 130b).

11. Device according to claim 9 or 10, characterized by the fact that the valve comprises an essentially disk-shaped valve body (134) that is oriented essentially parallel to the inlet opening (126) and essentially parallel to the outlet opening (152) in its closed position.

12. Device according to one of claims 9-11, characterized by the fact that the valve comprises an essentially disk-shaped valve body (134) that is oriented essentially parallel to the inlet opening (126) and essentially parallel to the outlet opening (152) in its open position.

13. Device according to claim 11 or 12, characterized by the fact that the device (100) comprises an actuating device (140) for moving the valve body (134) from the open position to the closed position and from the closed position to the open position.

14. Device according to claim 13, characterized by the fact that the actuating device (140) consists of a pneumatic and/or hydraulic actuating device.

15. Device according to one of claims 1-14, characterized by the fact that at least one outlet opening (152) of at least one receptacle (102) leads into a precombustion chamber (118) that is arranged between the outlet opening (152) and the heat storage mass (106) of the receptacle (102).

16. Device according to one of claims 1-15, characterized by the fact that the precombustion chamber (118) has the section (120) with an essentially constant cross section.

17. Device according to claim 16, characterized by the fact that at least one inlet opening (126) and/or at least one outlet opening (152) of the receptacle (102) lead(s) into the section (120) of the precombustion chamber (118) which has the essentially constant cross section.

18. Device according to one of claims 1-17, characterized by the fact that the precombustion chamber (118) has an essentially rectangular cross section.
